(19) United States
(12) Patent Application Publication
(10) Pub. No.: US 2013/0094255 A1
(43) Pub. Date: Apr. 18, 2013

(54) POWER FACTOR CORRECTION CIRCUIT CAPABLE OF ESTIMATING INPUT CURRENT AND CONTROL METHOD FOR THE SAME

(71) Applicants: Chia-An YEH, New Taipei City (TW); Hsiang-Yi CHEN, New Taipei City (TW)

(72) Inventors: Chia-An YEH, New Taipei City (TW); Hsiang-Yi CHEN, New Taipei City (TW)

(73) Assignee: ACBEL POLYTECH INC., New Taipei City (TW)

(21) Appl. No.: 13/589,362

(22) Filed: Aug. 20, 2012

(30) Foreign Application Priority Data
Oct. 13, 2011 (TW) 100137077

(51) Int. Cl. H02M 1/12

(52) U.S. Cl. 363/44

(57) ABSTRACT

A power factor correction circuit and a control method thereof uses a power factor controller to generate a compensation current signal according to an input voltage of an AC-DC conversion circuit and a filter capacitor value. An estimation current signal is generated by summing up the compensation current signal and an inductor current signal of the AC-DC conversion circuit. And then, a pulse width modulation signal is outputted to the AC-DC conversion circuit according to the estimation current signal. The filter capacitor value is chosen from a capacitor value of a capacitor connected to the AC power source, an input capacitor value of the AC-DC conversion circuit, or sum of both the capacitor values. Therefore the estimation current signal approaches an input current signal of the power factor correction circuit to increase the power factor at the input terminals of the power factor correction circuit and decrease a harmonic distortion.

### BACKGROUND OF THE INVENTION

1. Field of the Invention

The invention relates to a power factor correction circuit of a power supply and a control method thereof, and more particularly to a power factor correction circuit that is able to estimate the current of the AC power source of a power supply.

2. Description of Related Art

With reference to FIG. 10, a conventional power factor correction circuit of a power supply includes a rectifier 50, a power factor control circuit 60 and a DC-DC conversion circuit 80.

Two input terminals of the rectifier 50 could receive an AC power source (V_{AC}). The rectifier 50 has two input terminals connected to two terminals of a filter capacitor (Cₓ) and generates a sine wave DC voltage.

Two input terminals of the power factor control circuit 60 connect to the two output terminals of the rectifier 50 to receive the sine wave DC voltage. The two input terminals of the power factor control circuit 60 connect to another filter capacitor (Cᵢₙ). This power factor control circuit 60 could be a boost converter including an active switch 61.

Two output terminals of the power factor control circuit 60 connect to the DC-DC conversion circuit 80. Two output terminals of the DC-DC conversion circuit 80 connect to a load 90. The DC-DC conversion circuit 80 could convert a DC voltage (as 380V) of the power factor control circuit 60 to different DC voltages (such as 28V, 12V, etc.) for offering the DC voltages to the load 90.

With reference to FIG. 11, the power factor control circuit 60 includes a voltage loop control module 71, a current loop control module 72, and a driver 73. The voltage loop control module 71 refers to a deviation between an output voltage (Vₒᵤₜ)of the power factor control circuit 60 and a reference voltage (V_{ref1}), and an input voltage (Vᵢₙ) of the power factor control circuit 60 to generate a reference current signal (I_{ref}). The current loop control module 72 refers to a deviation between the reference current signal (I_{ref}) and an inductor current (I_{L}) of the power factor control circuit 60 to generate a duty cycle control signal. The driver 73 refers to the duty cycle control signal to output a pulse width modulation (PWM) signal to the active switch 61 to control duty cycles of the active switch 61. By this way, a waveform of the inductor current (I_{L}) will follow a waveform of the input voltage (Vᵢₙ) to improve a power factor at the input terminals of the power factor control circuit 60.

As stated above, the power factor and total harmonic distortions of the power factor control circuit 60 are improved by controlling the waveform of the inductor current (I_{L}) to follow the waveform of the input voltage (Vᵢₙ) of the power factor control circuit 60. However, as the AC power source (V_{AC}) is input to the two input terminals of the rectifier 50, modifying the input voltage and an input current (I_{AC}) of the rectifier 50 is the practical way to improve a power factor of the AC power source (V_{AC}).

FIG. 12 shows waveforms of the input voltage and the input current (I_{AC}) of the AC power source (V_{AC}). Because the inductor current (I_{L}) is different from the input current (I_{AC}), the conventional power factor correction method is inadequate for improving the power factor and the total harmonic distortions of the AC power source (V_{AC}).

### SUMMARY OF THE INVENTION

This invention relates to a power factor correction circuit for estimating and compensating for an input current. After estimating an effect of a filter capacitor on the power factor correction circuit and reference to an estimation current signal, the power factor can be calibrated to improve the power factor and total harmonic distortions of the AC power source.

For the purpose of achieving this invention, the power factor correction circuit includes:

an AC-DC conversion circuit, which has two input terminals and two output terminals, and a first filter capacitor which is connected between the two input terminals, the AC-DC conversion circuit having at least one inductor and at least one active switch;

a power factor controller, which connects to the AC-DC conversion circuit and has at least one output control terminal connected to at least one active switch. The power factor controller outputs a pulse width modulation (PWM) signal to at least one active switch. Duty cycles of the PWM signal refer to a deviation between an estimation current signal and a reference current signal. The estimation current signal is obtained by summing up a compensation current signal and an inductor current signal of the AC-DC conversion circuit, the compensation current signal is obtained by an input voltage of the AC-DC conversion circuit and a first filter capacitor value; the reference current signal is obtained by a deviation between an output voltage of the AC-DC conversion circuit and a reference voltage signal.

This invention also provides a control method for estimating an input current, the control method having steps as below:

generating a compensation current signal according to an input voltage of an AC-DC conversion circuit and a filter capacitor value;

generating an estimation current signal by summing up the compensation current signal and an inductor current signal of the AC-DC conversion circuit;

generating a reference current signal according to a deviation between an output voltage of the AC-DC conversion circuit and a reference voltage;

generating a duty cycle control signal according to a deviation between the estimation current signal and the reference current signal; and

outputting a pulse width modulation (PWM) signal to the AC-DC conversion circuit according to the duty cycle control signal.

This invention circuit could predict a current signal of a filter capacitor, the current signal is generated by the AC-DC conversion circuit, and a duty cycle of the PWM signal is controlled according to the estimation current signal. The PWM signal is not only based on the output voltage and current signal of the AC-DC conversion circuit to calibrate the power factor, but is also based on the estimation current signal. Therefore, this invention could improve the two input terminals of the AC-DC conversion circuit, which means the power factor could be improved and the total harmonic distortions could be reduced.

### BRIEF DESCRIPTION OF THE DRAWINGS

FIG. 1 is a circuit diagram of a power factor correction circuit of this invention;

FIG. 2 is a schematic diagram of a boost circuit;

FIG. 3 is a schematic diagram of a buck circuit;

FIG. 4 is a schematic diagram of a power factor correction circuit with a bridgeless rectifier;

FIG. 5 is a control block diagram of a power factor correction circuit of this invention;

FIG. 6 is a block diagram of an inductor current estimation module;

FIG. 7 is a waveform diagram of an input voltage and current of a rectifier as FIG. 1;

FIG. 8 is a block diagram of another inductor current estimation module;

FIG. 9 is a flow chart of a control method of this invention;

FIG. 10 is a schematic diagram of a power factor correction circuit of a prior art;

FIG. 11 is a control block diagram of the power factor correction circuit of FIG. 10; and

FIG. 12 is a waveform diagram of an input voltage and an input current of a rectifier as shown in FIG. 10.

### DETAILED DESCRIPTION OF PREFERRED EMBODIMENT

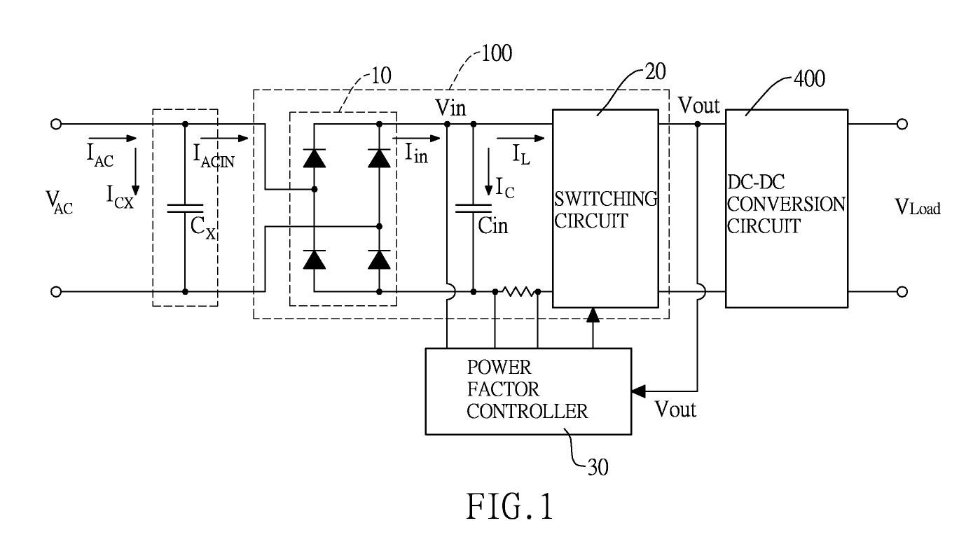

FIG. 1 shows a first embodiment of a power factor correction circuit of this invention. The power factor correction circuit has an AC-DC conversion circuit 100 and a power factor controller 30.

The AC-DC conversion circuit 100 includes two input terminals and two output terminals. A first filter capacitor (Cₓ) is connected between the two input terminals. The AC-DC conversion circuit includes at least one inductor (L), at least one capacitor (C) and at least one active switch. The two input terminals of the AC-DC conversion circuit 100 receive an AC power source (V_{AC}). The two output terminals of the AC-DC conversion circuit 100 could connect to a DC-DC conversion circuit 400 which could drop an output voltage of the AC-DC conversion circuit 100 to generate a low voltage DC power for offering a load.

In the first embodiment, the AC-DC conversion circuit 100 has a rectifier 10 and a switching circuit 20.

The rectifier 10 includes two input terminals and two output terminals. The two input terminals of the rectifier 10 could be used as the two input terminals of the AC-DC conversion circuit 100 to receive the AC power source (V_{AC}). The first filter capacitor (Cₓ) is connected between the two input terminals of the rectifier 10 for filtering and reducing electromagnetic interference (EMI). In this embodiment, the rectifier 10 is a full-bridge rectifier.

The switching circuit 20 has two input terminals, which are connected to the two output terminals of the rectifier 10. A second filter capacitor (Cᵢₙ) is connected between the two input terminals of the switching circuit 20 for filtering. The switching circuit 20 is used for converting a DC sign wave voltage output from the rectifier 10 to a DC voltage.

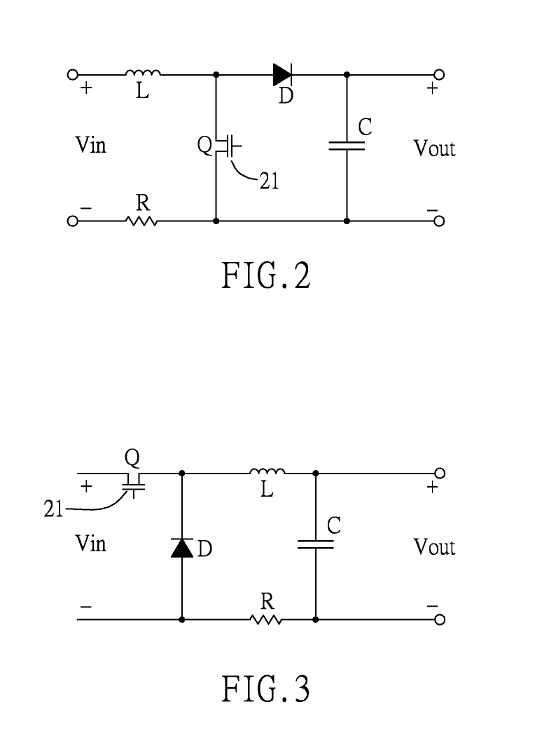

With reference to FIG. 2, the switching circuit 20 could be a boost circuit that has an inductor (L) and comprises an active switch 21, a diode (D), a capacitor (C) and a resistor (R). The active switch 21 has a control terminal. The inductor (L), the diode (D), the capacitor (C) and the resistor (R) are sequentially connected to form a loop, wherein one end of the inductor (L) and a first end of the resistor (R) are used as the two input terminals of the switching circuit 20 for connecting to the output terminals of the rectifier. The active switch 21 is electrically connected between an anode of the diode (D) and a second end of the resistor (R). A voltage across the capacitor (C) is used as the output voltage (Vₒᵤₜ) of the AC-DC conversion circuit 100.

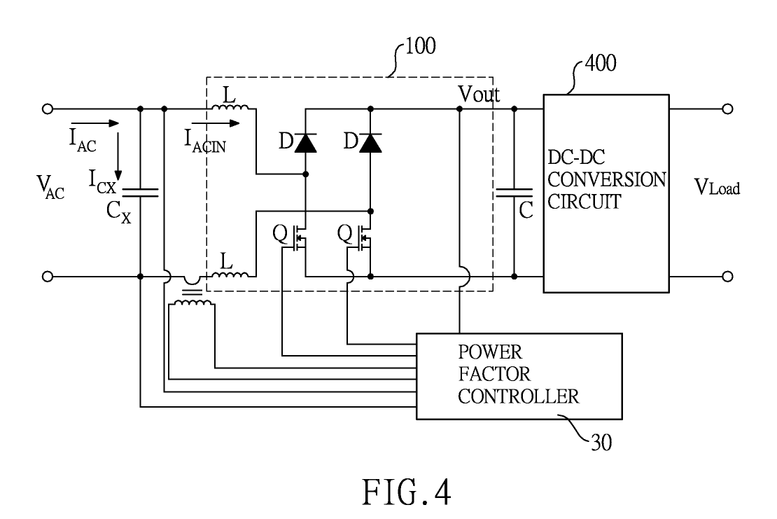

FIG. 3 shows that the switching circuit 20 could be a buck circuit that has an inductor (L), a capacitor (C), an active switch 21, a diode (D), and a resistor (R). The active switch 21 has a control terminal The active switch 21, the inductor (L), the capacitor (C) and the resistor (R) are sequentially connected to form a loop, wherein an anode of the diode (D) is connected to a first end of the resistor (R), and a cathode of the diode (D) is connected to a first end of the active switch 21 and one end of the inductor (L). A voltage across the capacitor (C) is used as the output voltage (Vₒᵤₜ) of the AC-DC conversion circuit 100. A second end of the active switch 21 and an anode of the diode (D) are used as the two input terminals of the switching circuit 20 to be electrically connected to the output terminals of the rectifier 10. FIG. 4 shows that the AC-DC conversion circuit 100 has two diodes (D), two active switches (Q) and two inductors (L). The two active switches (Q) connect to the two diodes (D) to construct a bridgeless rectifier. The two inductors (L) separately connect to two input terminals of the bridgeless rectifier to be the two input terminals of the AC-DC conversion circuit 100. Output voltage of the bridgeless rectifier is to be the output voltage (Vₒᵤₜ)of the AC-DC conversion circuit 100.

With reference to FIG. 1, the power factor controller 30 is electrically connected to the AC-DC conversion circuit 100 and has an output control terminal that connects to the active switch of the AC-DC conversion circuit 100. The power factor controller 30 outputs a pulse width modulation (PWM) signal to control the duty cycle of the active switch 21.

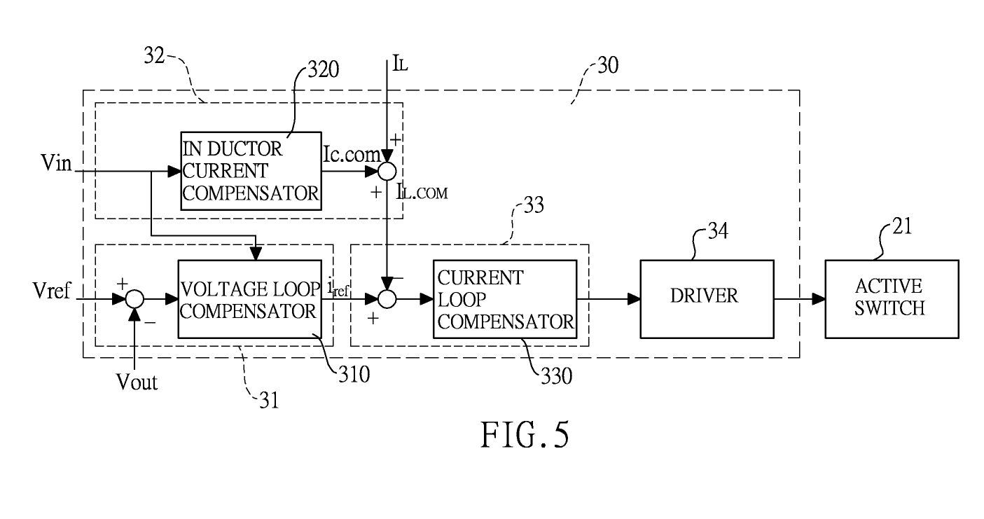

FIG. 5 shows that the power factor controller 30 has a voltage loop control module 31, an inductor current estimation module 32, a current loop control module 33 and a driver 34.

The voltage loop control module 31 receives a reference voltage (V_{ref}), an input voltage (Vᵢₙ) and an output voltage (Vₒᵤₜ) of the switching circuit 20. The voltage loop control module 31 has a voltage loop compensator 310. The voltage loop compensator 310 generates a reference current signal (i_{ref}) according to an input voltage (Vᵢₙ) and a deviation that is calculated from the output voltage (Vₒᵤₜ)and the reference voltage (V_{ref}).

The inductor current estimation module 32 connects to an input terminal of the switching circuit 20 and includes an inductor current compensator 320. A compensation current signal (I_{C,COM}) is generated according to the input voltage (Vᵢₙ) of the switching circuit 20 and a filter capacitor value. The filter capacitor value is chosen among the first filter capacitor (Cₓ) value, the second filter capacitor (Cᵢₙ) value, or sum of both the capacitor values (Cₓ+Cᵢₙ). The inductor current estimation module 32 sums up the compensation current signal (I_{C,COM}) and an inductor current signal (I_{L}) of the switching circuit 20 to generate an estimation current signal (I_{L,COM}).

Two input terminals of the current loop control module 33 are connected to output terminals of both the voltage loop control module 31 and the inductor current estimation module 32. The current loop control module 33 has a current loop compensator 330 that outputs a duty cycle control signal according to the reference current signal (i_{ref}) and the estimation current signal (I_{L,COM}).

The driver 34 is connected between the output terminal of the current loop control module 33 and the active switch 21 of the switching circuit. The driver 34 according to the duty cycle control signal outputs the PWM signal to the active switch 21.

The following steps explain how the compensation current signal (I_{C,COM}) is produced. With reference to FIG. 2, an input terminal voltage of the AC-DC conversion circuit 100 and the input voltage (Vᵢₙ) of the switching circuit 20 have a relation:

V_{AC}=Vᵢₙ=Vᵢₙₚₑₐₖ sin wt

This relation is conditional on 0<ωt<π and without considering a voltage drop of the diode of the rectifier 10.

A first current signal (I_{CX}) of the first filter capacitor (Cₓ) and a second current signal (I_{C}) of the second filter capacitor (Cᵢₙ) have a continuous representation:

$$I = C \frac{d V}{d t}$$

Therefore, the discrete representation of the capacitor current could be deduced as below:

$${I}_{CX} = \frac{{C}_{X}}{{T}_{S}} ( {V}_{in} [ n ] - {V}_{in} [ n - 1 ] )$$

$${I}_{C} = \frac{{C}_{in}}{{T}_{S}} ( {V}_{in} [ n ] - {V}_{in} [ n - 1 ] )$$

In the representation, Vᵢₙ[n] is a currently sampled value of the voltage (Vᵢₙ)and Vᵢₙ[n−1] is a previously sampled value of the input voltage

I_{L}=Iᵢₙ−I_{C}

Iᵢₙ₌I_{ACIN}=(I_{AC}−I_{CX})

I_{L}=(I_{AC}−I_{CX})−I_{C}

After transpose, the formula is as below,

I_{AC}=I_{L}+I_{CX}+I_{C}

so,

$$\begin{matrix}{I}_{L , COM} = {I}_{AC} \\ = {I}_{L} + ( {I}_{CX} + {I}_{C} ) \\ = {I}_{L} + {C}_{in} \frac{{V}_{in} [ n ] - {V}_{in} [ n - 1 ]}{{T}_{S}} + {C}_{X} \frac{{V}_{in} [ n ] - {V}_{in} [ n - 1 ]}{{T}_{S}} \\ = {I}_{L} + ( {C}_{in} + {C}_{X} ) \frac{{V}_{in} [ n ] - {V}_{in} [ n - 1 ]}{{T}_{S}}\end{matrix} \qquad ( 1 )$$

In formula (1), I_{L,COM} is an estimation current; I_{AC} is an output current of the AC power source; I_{CX} is a capacitor current; I_{ACIN} is an input current of the rectifier 10; Iᵢₙ is an output current of the rectifier 10; I_{C} is a capacitor current; I_{L} is an inductor current, and Vᵢₙ[n] is a sampled input voltage. Because the current signal (I_{CX}) of the first filter capacitor (C_{X}) and the current signal (I_{C}) of the second filter capacitor (Cᵢₙ) are un-measurable by the switching circuit 20, according to the formula (1), this invention provides the estimation current (I_{L,COM}) that is a sum of the inductor current (I_{L}) of the switching circuit 20, the current signal (I_{CX}) of the first filter capacitor (C_{X}), and the current signal (I_{C}) of the second filter capacitor (Cᵢₙ) for approaching the output current (I_{AC}) of the AC power source (V_{AC}).

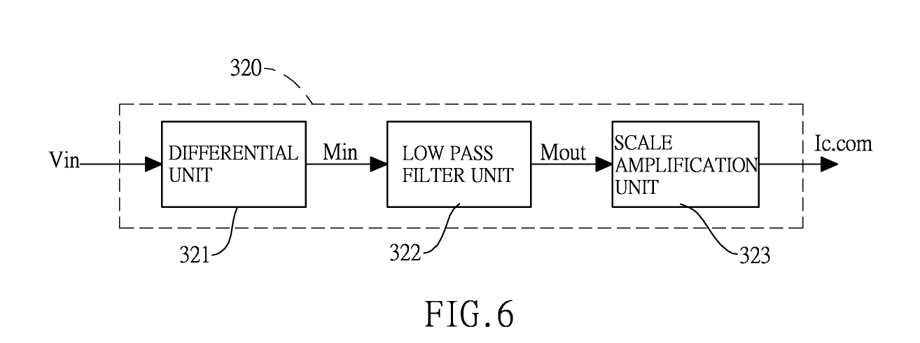

According to the result of the estimation current signal (I_{L,COM}) and with reference to FIG. 6, the inductor current compensator 320 has a differential unit 321 and a scale amplification unit 323, or further, a low pass filter unit 322 connected between the differential unit 321 and the scale amplification unit 323. The differential unit 321 performs with a differentiation on the input voltage (Vᵢₙ) of the switching circuit 20. If the input voltage of the switching circuit is
Vᵢₙ(t)=Vᵢₙₚₑₐₖ sin wt , so

$${M}_{in} ( t ) = \frac{d {V}_{inpeak} sin wt}{d t} = {wV}_{inpeak} cos wt , \qquad ( 2 )$$

the discrete representation (2) could be rewritten as below,

$${M}_{in} [ t ] = \frac{{V}_{in} [ n ] - {V}_{in} [ n - 1 ]}{{T}_{S}}$$

The scale amplification unit 323 provides a filter capacitor value, which is chosen from the value of the first filter capacitor (C_{S}), the second filter capacitor (Cᵢₙ), or the sum of both the capacitors (Cᵢₙ+Cₓ). In the embodiment, the filter capacitor value is Cin+Cx, therefore a compensation current signal (I_{C,COM}) could be deduced and the continuous representation is

I_{C,COM}(t)=(Cᵢₙ+C_{X})Mᵢₙ(t)=(Cᵢₙ+C_{X})wVᵢₙₚₑₐₖ cos wt (3)

, the discrete representation of the formula (3) is

$${I}_{C , COM} [ n ] = ( {C}_{in} + {C}_{X} ) \frac{{V}_{in} [ n ] - {V}_{in} [ n - 1 ]}{{T}_{S}} ,$$

so the formula (1) could be rewritten to

I_{L,COM}=I_{L}+I_{C,COM}

, and the low pass filter unit 322 is used to filter noises in the input voltage (Vᵢₙ) being differentiated. The low pass filter unit 322 could provide a filtering parameter (LPF). Therefore, the estimation current signal (I_{L,COM}) can be rewritten to

I_{L,COM}=I_{L}+I_{C,COM}·LPF

With reference to Table 1 and Table 2, the power factor correction data with the estimation current signal (I_{L,COM}) and without the estimation current signal (I_{L,COM}) are respectively showed.

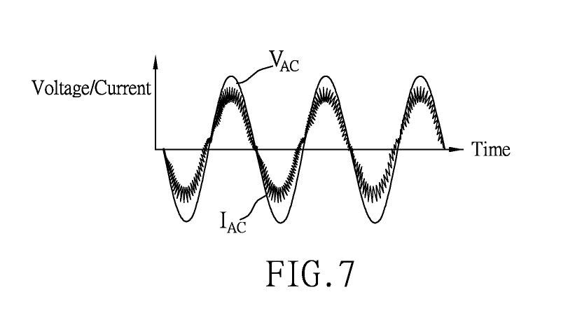

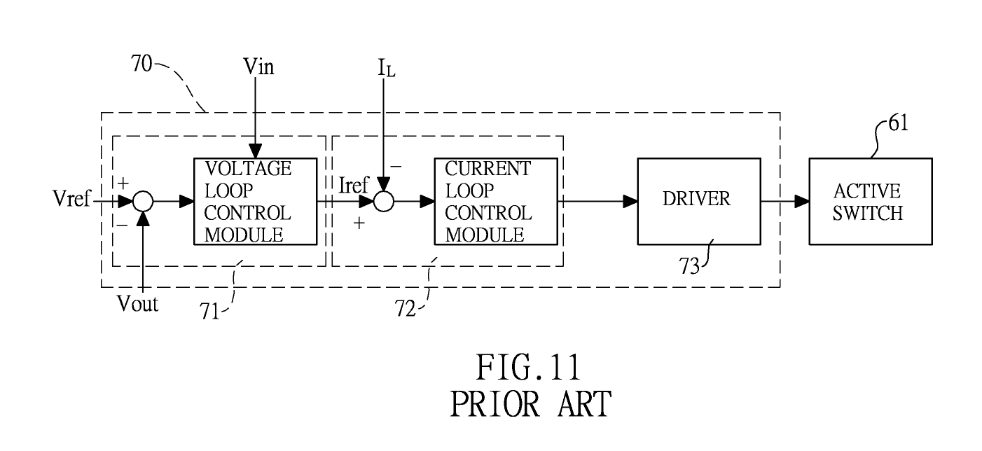

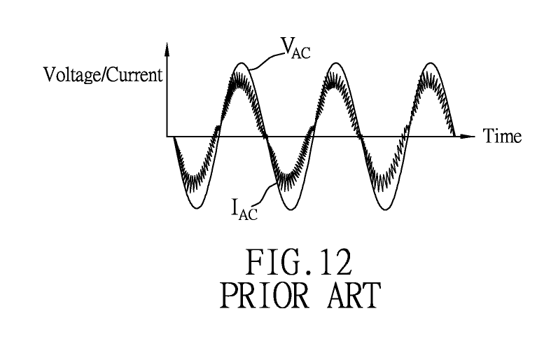

After adding the estimation current signal (I_{L,COM}), a power factor (PF) at the two input terminals of the AC-DC conversion circuit 100 is increased and a harmonic distortion is obviously decreased. Comparing FIG. 7 with FIG. 11, the input terminal current (I_{AC}) waveform of the AC-DC conversion circuit 100 is closer to the voltage (V_{AC}) waveform.

Vᵢₙ: 230 V, Vₒᵤₜ: 395 V

| | | | | |
|---|---|---|---|---|
| Loading | 10% | 20% | 50% | 100% |

Before adding the estimation current signal

| | | | | |
|---|---|---|---|---|
| Power Factor | 0.7863 | 0.9014 | 0.9743 | 0.9911 |
| Harmonic Distortion | 13.59 | 9.25 | 7.11 | 2.3 |

After adding the estimation current signal

| | | | | |
|---|---|---|---|---|
| Power Factor | 0.8205 | 0.9032 | 0.9807 | 0.995 |
| Harmonic Distortion | 8.45 | 8.09 | 5.6 | 2.15 |

Table 1 shows the power factors and harmonic distortion with the estimation current signal and without the estimation current signal.

Vᵢₙ: 230 V, Vₒᵤₜ: 340 V

| | | | |
|---|---|---|---|
| Loading | 10% | 20% | 50% |

Before adding the estimation current signal

| | | | |
|---|---|---|---|
| Power Factor | 0.7912 | 0.9102 | 0.9757 |
| Harmonic Distortion | 17.97 | 13.55 | 7.32 |

After adding the estimation current signal

| | | | |
|---|---|---|---|
| Power Factor | 0.8207 | 0.9265 | 0.9845 |
| Harmonic Distortion | 15.1 | 11.67 | 5.09 |

Table 2 shows the power factors and harmonic distortion with the estimation current signal and without the estimation current signal.

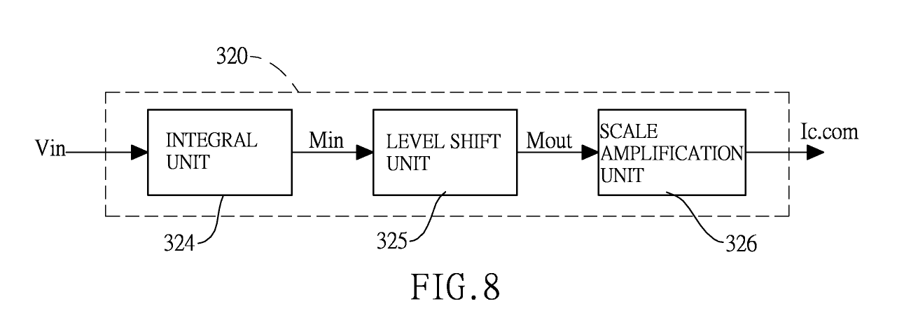

With reference to FIG. 8, which is a second embodiment of this invention, the current compensator 320 has an integral unit 324, a level shift unit 325 and a scale amplification unit 326. The input voltage (Vᵢₙ) of the switching circuit 20 is integrated by the integral unit 324. After integrating, the continuous representation is

$${M}_{in} ( t ) = {\int }_{0}^{t} {V}_{inpeak} sin w τ d τ = \frac{{V}_{inpeak}}{w} ( 1 - cos wt ) ,$$

, and the level shift unit 325 provides a first default scale parameter

$$- \frac{{V}_{inpeak}}{w} , so {M}_{out} ( t ) = {M}_{in} ( t ) - \frac{{V}_{inpeak}}{w} = - \frac{{V}_{inpeak}}{w} cos wt .$$

The scale amplification unit 326 provides a second default scale parameter −(Cₗᵢₙ+C_{X})ω², so

I_{C,COM}(t)=Mₒᵤₜ(t)·[−(Cᵢₙ+C_{X})ω²]=(Cᵢₙ+C_{X})wVᵢₙₚₑₐₖ cos wt (4).

Wherein the discrete representation (4) could be rewritten to

I_{C,COM}[n]=(Cᵢₙ+C_{X})(Vᵢₙ[n]−Vᵢₙ[n−1])

, so the discrete representation (4) of the second embodiment and the discrete representation (3) of the first embodiment could get the same results.

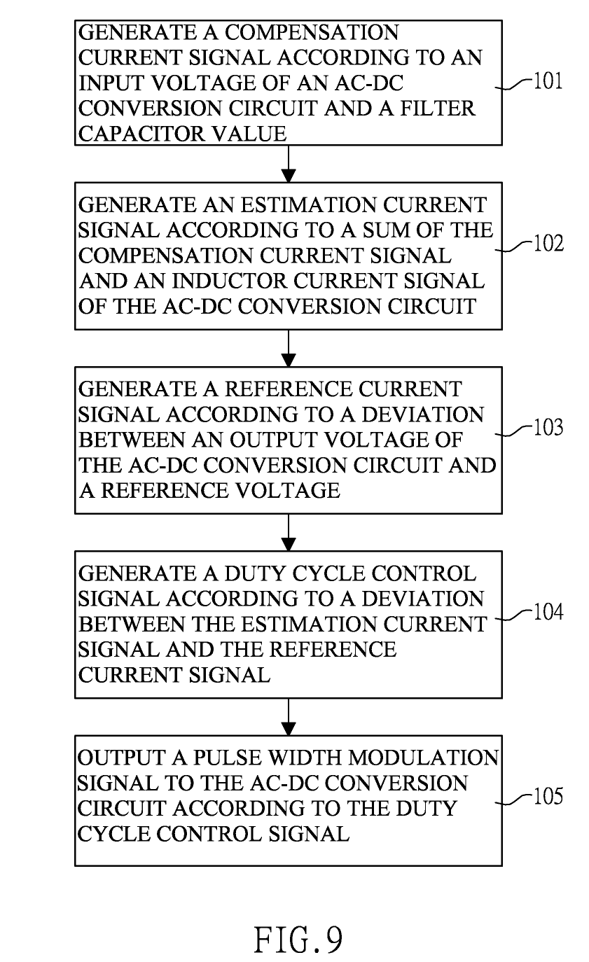

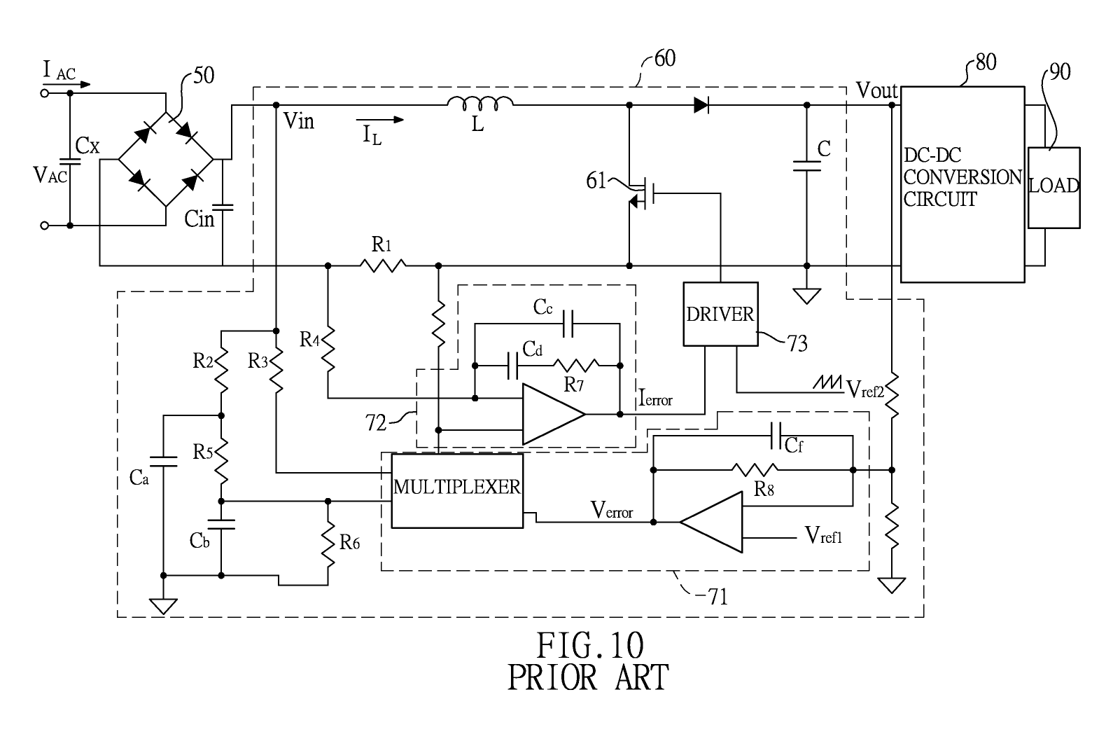

To summarize, with reference to FIG. 9, the method executed by the power factor correction circuit has steps as below:

generating a compensation current signal (I_{C,COM}) according to an input voltage (Vᵢₙ) of an AC-DC conversion circuit 100 and a filter capacitor value (STEP 101);

generating an estimation current signal (I_{L,COM}) according to a sum of the compensation current signal (I_{C,COM}) and an inductor current signal (I_{L}) of the AC-DC conversion circuit 100 (STEP 102);

generating a reference current signal (i_{ref}) according to a deviation between an output voltage (Vₒᵤₜ) of the AC-DC conversion circuit 100 and a reference voltage (V_{ref}) (STEP 103);

generating a duty cycle control signal according to a deviation between the estimation current signal (I_{L,COM}) and the reference current signal (i_{ref}) (STEP 104); and

outputting a pulse width modulation signal to the AC-DC conversion circuit 100 according to the duty cycle control signal (STEP 105). In the step of generating a compensation current signal (I_{C,COM})(STEP 101) of the first embodiment, the input voltage (Vᵢₙ) is differentiated and amplified to generate the compensation current signal (I_{C,COM}); or the input voltage (Vᵢₙ) is differentiated to pass through a low pass filter and performed with a scale amplification to generate the compensation current signal (I_{C,COM}).

In the step of generating the compensation current signal (I_{C,COM})(STEP 101) of the second embodiment, the input voltage (Vᵢₙ) is integrated, shifted and performed with the scale amplification to generate the compensation current signal (I_{C,COM}).

To summarize, the inductor current estimation module according to the input voltage (Vᵢₙ) of the AC-DC conversion circuit 100 and the filter capacitor value generates the estimation current signal (I_{L,COM}) which approaches the input current (I_{AC}) that is received from the AC power source (V_{AC}). The power factor correction circuit according to the estimation current signal (I_{L,COM}) outputs the pulse width modulation signal to control the current (I_{AC}) waveform of the two input terminals of the AC-DC conversion circuit 100 to approach a voltage waveform of the AC power source (V_{AC}) of a power supply for increasing the power factor of the two input terminals of the AC-DC conversion circuit 100 and decreasing the harmonic distortion.

What is claimed is:

1. A power factor correction circuit for estimating an input current comprising:
an AC-DC conversion circuit having two input terminals and two output terminals, a first filter capacitor connected between the two input terminals, the AC-DC conversion circuit having at least one inductor and at least one active switch, the at least one inductor connected to the at least one active switch;
a power factor controller connected to the AC-DC conversion circuit and having at least one output control terminal connected to the at least one active switch, the power factor controller outputting a pulse width modulation signal to the at least one active switch, wherein
a duty cycle of the pulse width modulation signal is determined based on a deviation between an estimation current signal and a reference current signal;
the estimation current signal is produced by summing up a compensation current signal and the inductor current signal of the AC-DC conversion circuit, the compensation current signal is produced based on an input voltage of the AC-DC conversion circuit and the first filter capacitor value; and
the reference current signal is produced based on a deviation between an output voltage of the AC-DC conversion circuit and a reference voltage signal.

2. The power factor correction circuit as claimed in claim 1, the power factor controller comprising:
a voltage loop control module having a voltage loop compensator which is used to generate the reference current signal;
an inductor current estimation module, which is used to generate the estimation current signal, wherein the inductor current estimation module has an inductor current compensator to generate the compensation current signal;
a current loop control module producing a duty cycle control signal according to the reference current signal and the estimation current signal; and
a driver according to the duty cycle control signal to generate the pulse width modulation signal.

3. The power factor correction circuit as claimed in claim 2, wherein the inductor current estimation module comprises:
a differential unit, which differentiates the input voltage of the AC-DC conversion circuit; and
a scale amplification unit providing a scale parameter.

4. The power factor correction circuit as claimed in claim 3, wherein the inductor current estimation module further has a low pass filter unit connected between the differential unit and the scale amplification unit.

5. The power factor correction circuit as claimed in claim 2, wherein the inductor current estimation module further comprises:
an integral unit, integrating the input voltage of the AC-DC conversion circuit;
a level shift unit, shifting the integral results; and
a scale amplification unit, providing a default scale parameter.

6. The power factor correction circuit as claimed in claim 1, the AC-DC conversion circuit comprising:
a rectifier, two input terminals of the rectifier being the two input terminals of the AC-DC conversion circuit; and
a switching circuit, which is a boost circuit, having an inductor, an active switch, a diode, a capacitor and a resistor, the active switch having a control terminal; wherein the inductor, the diode, the capacitor and the resistor are sequentially connected to form a loop, one end of the inductor and one end of the resistor are used as the two input terminals of the switching circuit for electrically connecting to the output terminals of the rectifier; the active switch is electrically connected between an anode of the diode and a first end of the resistor; a voltage across the capacitor is used as the output voltage of the AC-DC conversion circuit.

7. The power factor correction circuit as claimed in claim 1, the AC-DC conversion circuit comprising:
a rectifier, two input terminals of the rectifier being the two input terminals of the AC-DC conversion circuit; and
a switching circuit being a buck circuit having an inductor and an active switch, a diode, a capacitor and a resistor, the active switch having a control terminal, wherein the active switch, the inductor, the capacitor and the resistor are sequentially connected to form a loop, an anode of the diode is connected to one end of the resistor, cathode of the diode is connected to one end of the active switch and one end of the inductor; a voltage across the capacitor is used as the output voltage of the AC-DC conversion circuit; one end of the active switch and anode of the diode are used as the two input terminals of the switching circuit to be electrically connected to the output terminals of the rectifier.

8. The power factor correction circuit as claimed in claim 1, the AC-DC conversion circuit comprising:
two diodes;
two active switches electrically connected to the two diodes to construct a bridgeless rectifier, an output voltage of the bridgeless rectifier being the output voltage of the AC-DC conversion circuit; and
two inductors respectively connected to two input terminals of the bridgeless rectifier to be the two input terminals of the AC-DC conversion circuit.

9. A control method for a power factor correction circuit, the method comprising:
generating a compensation current signal according to an input voltage of an AC-DC conversion circuit and a filter capacitor value;
generating an estimation current signal by summing up the compensation current signal and an inductor current signal of the AC-DC conversion circuit;
generating a reference current signal according to a deviation between an output voltage of the AC-DC conversion circuit and a reference voltage;
generating a duty cycle control signal according to a deviation between the estimation current signal and the reference current signal; and
outputting a pulse width modulation signal to the AC-DC conversion circuit according to the duty cycle control signal.

10. The control method as claimed in claim 9, the step of generating the compensation current signal further comprising:
performing with a differentiation operation and a scale amplification on the input voltage of the AC-DC conversion circuit to generate the compensation current signal.

11. The control method as claimed in claim 10, wherein after the output voltage of the AC-DC conversion circuit is differentiated, the output voltage of the AC-DC conversion circuit passes through a low pass filter before the scale amplification.

12. The control method as claimed in claim 9, wherein in the step of generating the compensation current signal, the input voltage of the AC-DC conversion circuit is differentiated, shifted and performed with the scale amplification to generate the compensation current signal.
